(19) United States
(12) Patent Application Publication
(10) Pub. No.: US 2013/0035054 A1
(43) Pub. Date: Feb. 7, 2013

(54) PHONE WITH MULTI-PORTAL ACCESS FOR DISPLAY DURING INCOMING AND OUTGOING CALL

(71) Applicant: Jason A. Ashton, Santa Cruz, CA (US)

(72) Inventor: Jason A. Ashton, Santa Cruz, CA (US)

(73) Assignee: FACEON MOBILE, Santa Cruz, CA (US)

(21) Appl. No.: 13/547,224

(22) Filed: Jul. 12, 2012

Related U.S. Application Data
(60) Provisional application No. 61/507,953, filed on Jul. 14, 2011.
(60) Provisional application No. 61/537,969, filed on Sep. 22, 2011.

(51) Int. Cl. H04W 4/16; H04W 4/22

(52) U.S. Cl. 455/404.1; 455/415

(57) ABSTRACT

A phone allows a user to input profile data that is provided to another phone upon the phone calling or receiving a call from the another phone. The profile data does not need to be stored at the another phone. The profile data includes an image that is displayed at the another phone upon an incoming or outgoing call.

### CLAIM OF PRIORITY

This application claims priority to U.S. Application No. 61/507,953 entitled: “PHONE WITH MULTI-PORTAL ACCESS FOR DISPLAY DURING INCOMING AND OUTGOING CALLS”, by Jason A. Ashton, filed Jul. 14, 2011, and to U.S. Application No. 61/537,969 entitled: “PHONE WITH MULTI-PORTAL ACCESS FOR DISPLAY DURING INCOMING AND OUTGOING CALLS”, by Jason A. Ashton, filed Sep. 22, 2011, which are incorporated herein by reference.

### BACKGROUND

A Smartphone is a high-end mobile phone that offers advanced computing ability and connectivity. Smartphone's combine the functions of a personal digital assistant (PDA) and a mobile phone. Today's models typically also serve as portable media players and camera phones with high-resolution touchscreen, GPS navigation, Wi-Fi and mobile broadband access. Smartphone's use mobile operating systems that can run third-party applications.

Growth in demand for advanced mobile devices boasting powerful processors and graphics processing units, abundant memory, and high-resolution screens with multi-touch capability, and open operating systems has outpaced the rest of the mobile phone market for several years. Over 45.5 million people in the United States own Smartphones out of 234 million total subscribers.

Conventional Smartphones, however, do not provide caller information and other data for unknown numbers. Typically, the user is required to manually associate name and picture data with a telephone number. This allows the name and picture to be displayed when a call to that number is made or received. For calls made to and received from unknown numbers, however, the user is typically in the dark about the other party to the call.

### SUMMARY

Embodiments of the present invention are a system that does not require that a user manually add name and image information to be associated with a telephone number of another user.

A person inputs or links to profile data that can be stored at a server to be provided to and displayed at the phone of the other party to a call.

The display can include information from and links to social networking sites, such as LinkedIn and Facebook.

The display can be associated with an email address of the other party to the call. The latest emails to and from the other party can be linked from the display. Portions of these messages can also be provided in the display. Similar displays of the latest text messages, such as SMS messages, can be accessible from the display and portions of the text messages displayed in the display.

The profile data, image and links to social networking sites can be selectable by the user.

### BRIEF DESCRIPTION OF THE DRAWINGS

FIGS. 1A-C show exemplary prior art displays for incoming and outgoing calls for unknown telephone numbers.

FIG. 2A shows an exemplary display of an embodiment of the present invention that can be provided to a party of a call.

FIG. 2B shows an exemplary system of one embodiment of the present invention.

FIG. 3 shows an exemplary setup screen for the display of one embodiment of the present invention.

FIG. 4 shows an input screen for registration information for the display service of one embodiment.

FIGS. 5A-C shows screens for the input of registration information through a social network site, such as Facebook.

FIGS. 6A-B show separate profile screens for incoming and outgoing calls.

FIG. 7 shows a map display using user information from an identification service.

FIG. 8 shows an exemplary image import system to select images for the display.

FIG. 9 shows a dynamic multi-portal call log display.

FIG. 10 shows dynamic multi-portal contacts display.

FIG. 11 shows a dynamic multi-portal text messages display.

FIG. 12 shows the real time access of a person's social network during a call.

FIG. 13 shows the dynamic gift delivery during a call.

FIG. 14A-C shows “one screen” instant calling and text messaging without leaving the call screen.

FIG. 15 shows a screen for emergency features of a phone of one embodiment.

FIG. 16 shows a flow chart of one embodiment of the present invention.

FIG. 17 shows an emergency system of one embodiment of the present invention.

FIGS. 18A and 18B shows a notification example of one embodiment of the present invention.

FIG. 19 illustrates a system that populates a search engine box on a phone with caller information.

FIG. 20 shows exemplary phone buttons of one embodiment.

### DETAILED DESCRIPTION

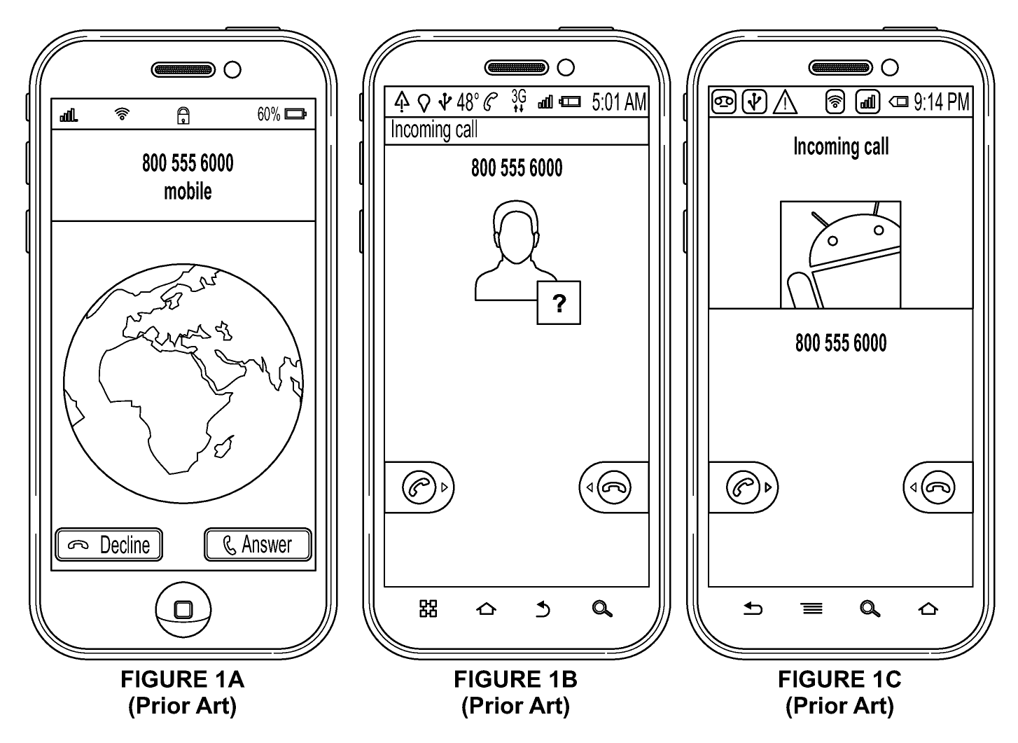

FIGS. 1A-C show exemplary prior art displays for incoming and outgoing calls for unknown telephone numbers. Each of these prior art displays typically leaves the user in the dark about the other party to the call.

Embodiments of the present invention are phones that allow a user to input profile data that is provided to another phone upon the phone calling or receiving a call. The profile data need not be stored at the another phone. The profile data includes an image that is displayed at the another phone upon an incoming or outgoing call.

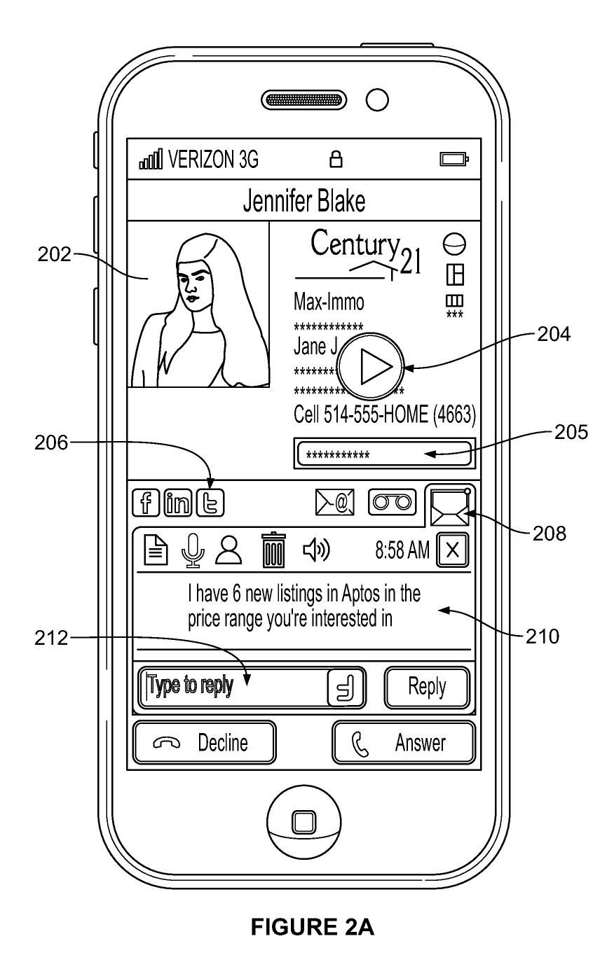

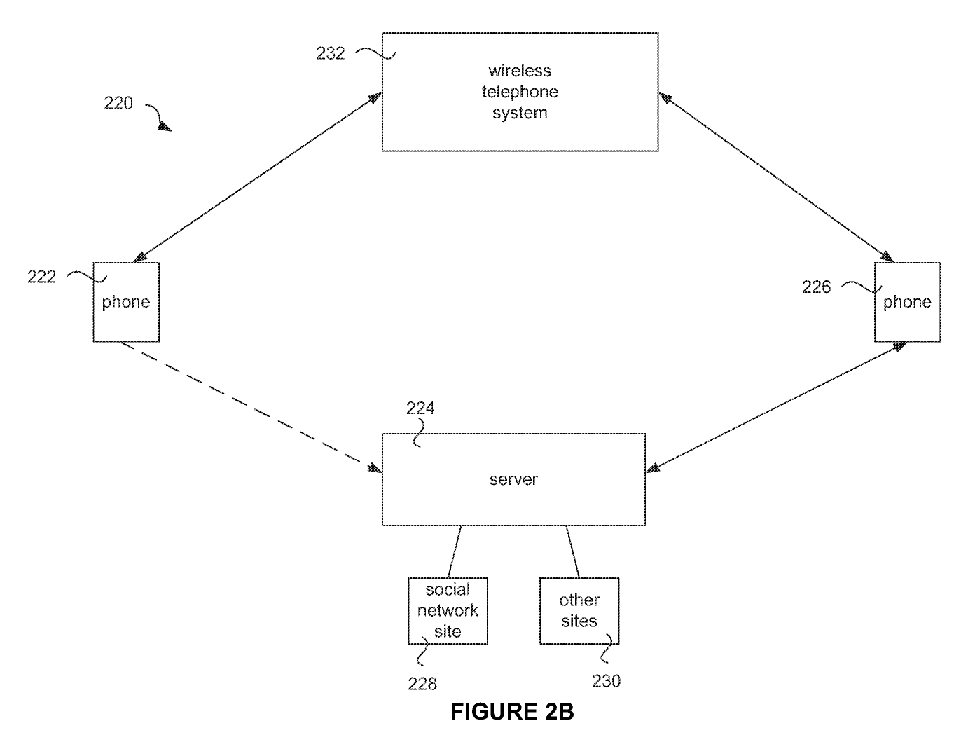

FIG. 2A shows an exemplary display 202 that can be provided to a party to a call. This display includes an image 204. An image center can be used to enable callers to attach and send images and video as part of the caller's ID.

An email access portion 205 can provide a short key to the email address of the other party to the call. Clicking on the email address can send the user to an email page where an email can be sent during the call.

A profile portion 206 can provide access to the profile and social networks of the other party of the call. The profile portion 206 can notify the users of past and recent text, video messages, emails and voicemails related to the other party to the call.

A message portion 208 can provide access to messages from the other party to the call. A message preview section 210 can show preview of past and recent messages, such as emails and text messages. This helps the user to have a context to the call. Reply portion 212 can allow instant reply via email, chat, text, or voicemail.

FIG. 2B shows a system 220 for implementing embodiments of the present invention. Phone 222 can register with server 224 to allow for displays such as display 202 of FIG. 2A to be provided to another phone, such as phone 226. The server can store a correspondence between the telephone number for phone 222 and the data to be displayed at the phone 226.

During an incoming or outgoing call between phone 222 and phone 226, phone 226 can obtain display information from server 224. The server 224 can obtain updates from social network sites 228 and other sites 230.

Alternately, the server 224 can provide pointers or links to these sites 228 and 230 and the phone can independently get display information from sites 228 and 230. The phone 226 can cache this display information and update it as needed.

The server 224 can be part of or independent of the wireless telephone system 232 setting up the call.

One embodiment of the present invention is a server 224 to provide image and other data to a phone 226 upon incoming and outgoing calls from a second phone 222. The server 224 provides the image for a user who has set up a profile. The image being provided to the phone from the server 224 without the image needing to be stored at the phone. The image is displayed at the phone 226 upon an incoming or outgoing call.

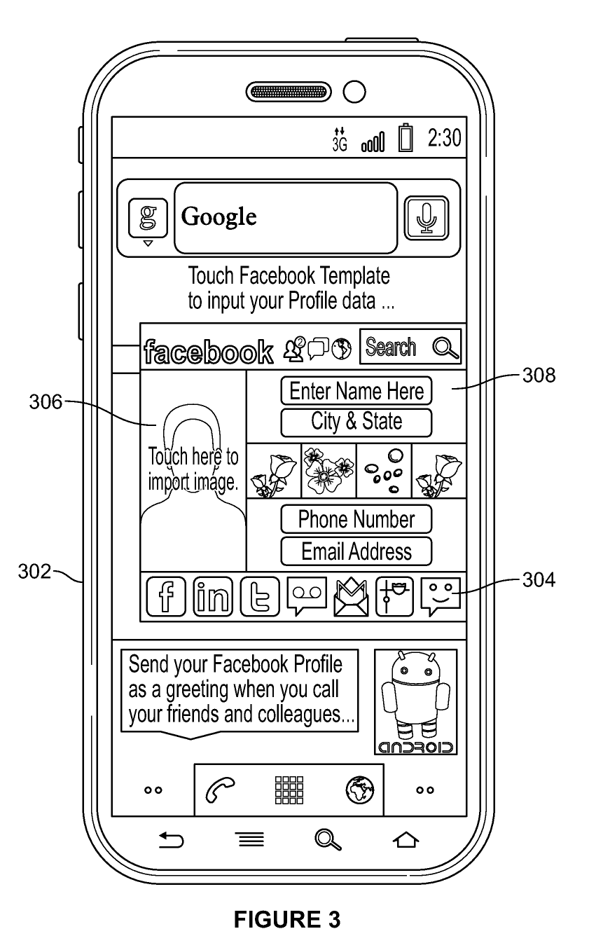

FIG. 3 shows an exemplary setup screen 302 for the display. Screen 302 allows for data to be inputted for the display to other party to the call. Icons 304 allow the selection of features for the display. For example, features shown in the display 202 of FIG. 2A can be enabled or disabled using setup screen 302.

Section 306 of the setup screen 302 allows for the input of an image for the display. Section 308 of the setup screen 302 allows for the input of other user data.

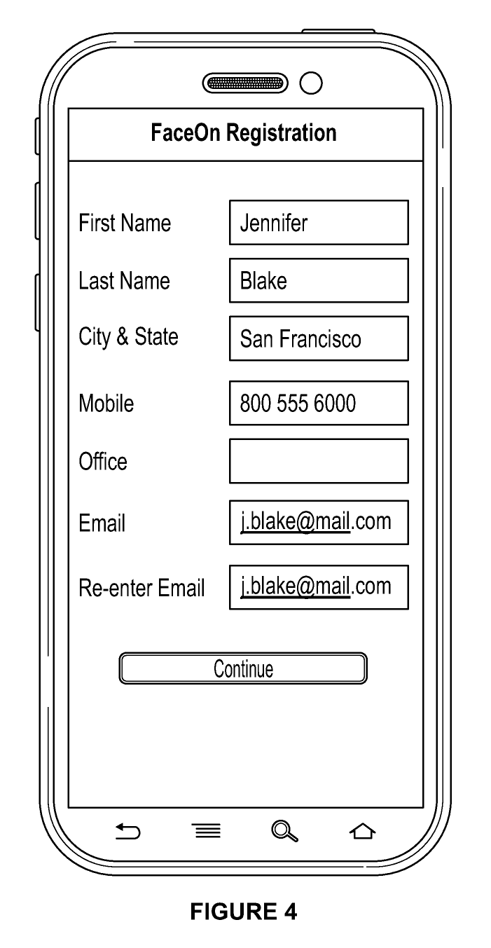

FIG. 4 shows the input of registration information for the display service. This manual input screen allows the user to input name, address and email and other information.

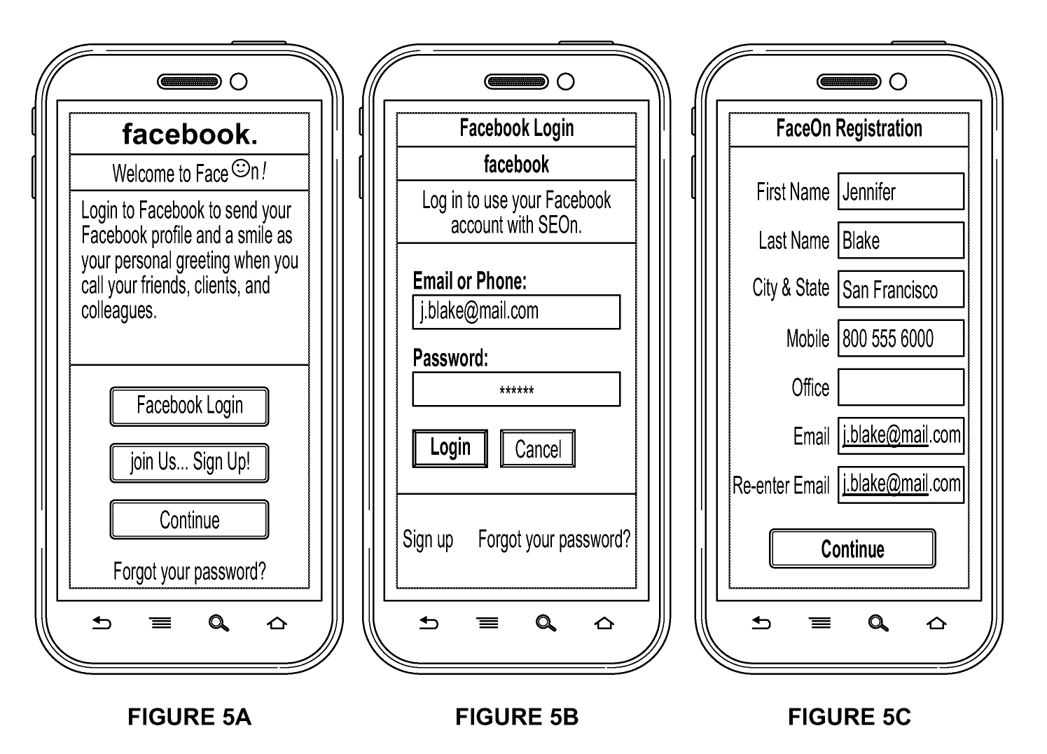

FIGS. 5A-C show screens for the automatic input of information through a social network or other site, such as Facebook.

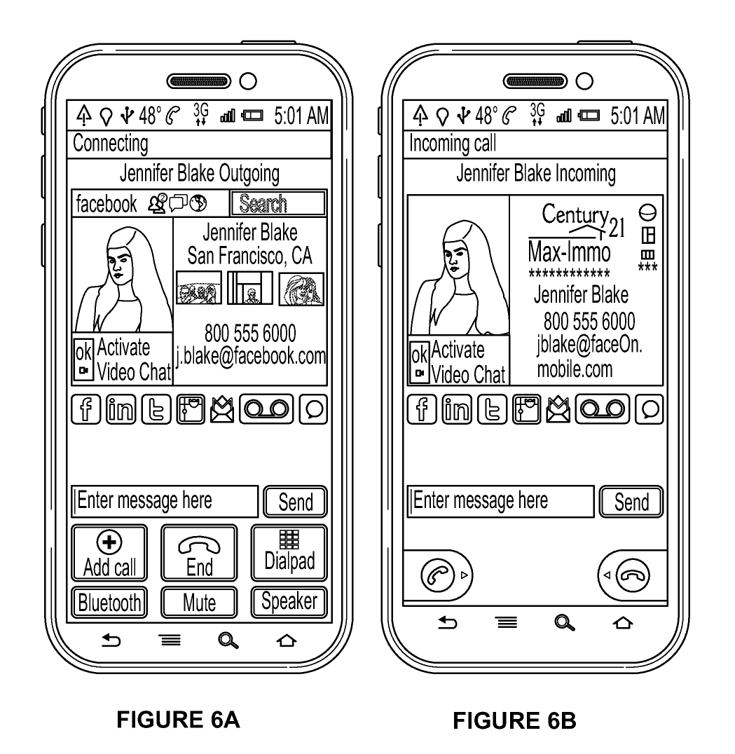

FIGS. 6A-B show screens for separate profiles for incoming and outgoing calls. For example, the incoming profile can be more business oriented, while the outgoing call display can be more personal.

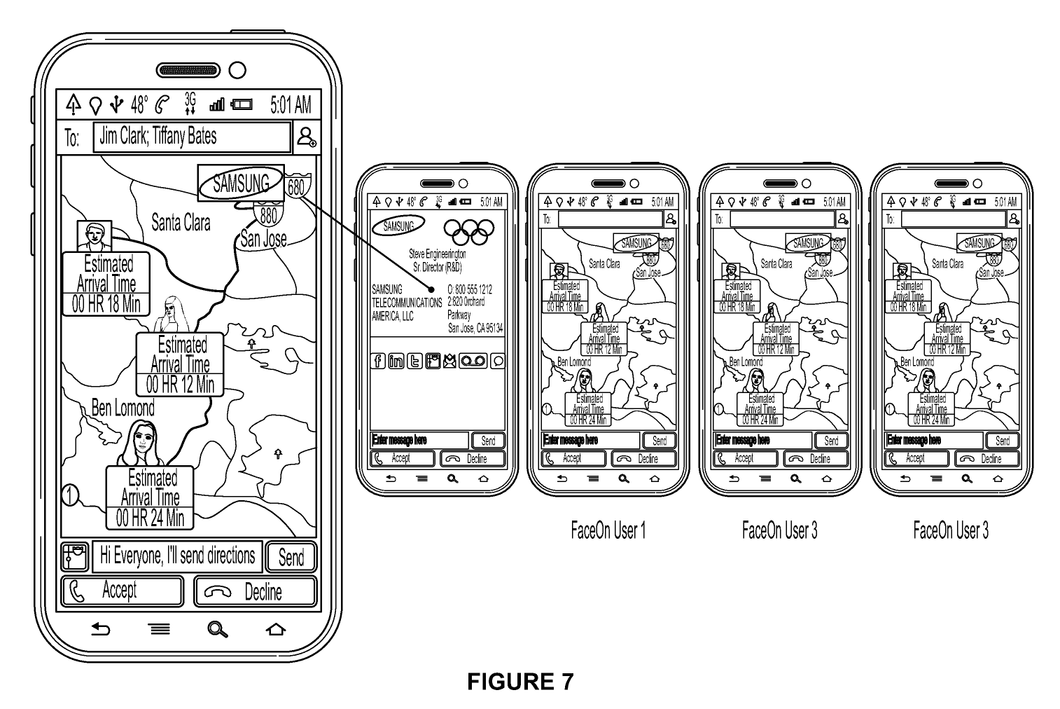

FIG. 7 shows a dynamic multiuser navigation system. The multiuser navigation system dynamically extracts addresses associated with the profile information and delivers one click driving directions to multiple users. Users can see the location of other users who have elected to publish their location on the map. The system estimates arrival time of each user and publishes these arrival times.

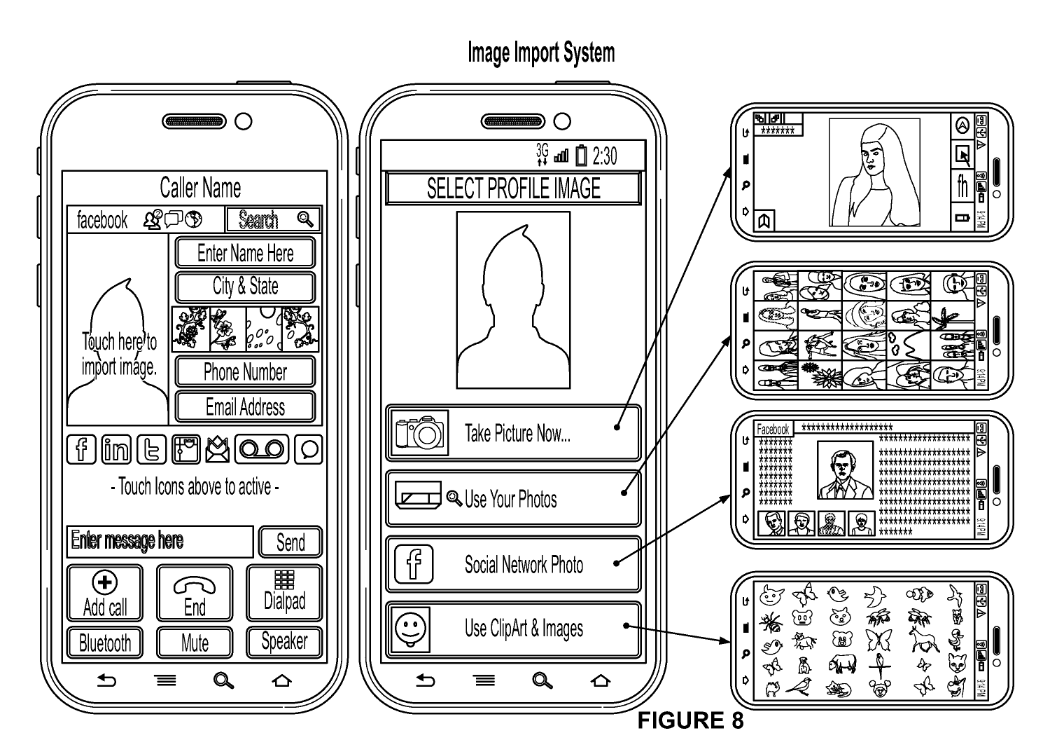

FIG. 8 shows an exemplary image import system to select images for the display. In this example, the phone can be used as a camera to take the image, the image can be selected from stored photos, the image can be extracted or linked from a social network or other site, or clip art can be used as the image.

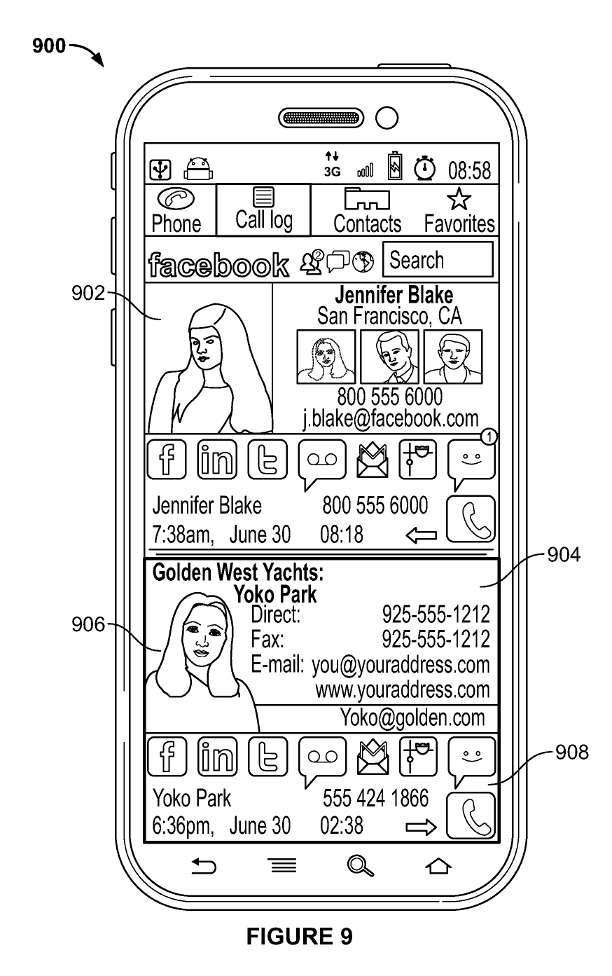

FIG. 9 shows a dynamic multi-portal call log screen. The multi-portal call log can dynamically integrate rich, relevant data into each call, recent or archived. Users can see who has called with digital business cards. Quick and easy to use-search social networks, voicemails, emails, text messages, can be done all on one screen. Up to date social network profiles, past and recent text messages, voice mails, emails and more can be obtained from this single screen.

The system can provide real time data and information. For example, social network profiles, tweets, text messages, emails days after recent and missed calls have been logged onto the same screen.

The system can make sending and receiving email quick and easy. Simply touch the email address on the call log and you are ready to type and send. Current and archived email, text messages, voicemails can be dynamically updated when contacts are touched even days later.

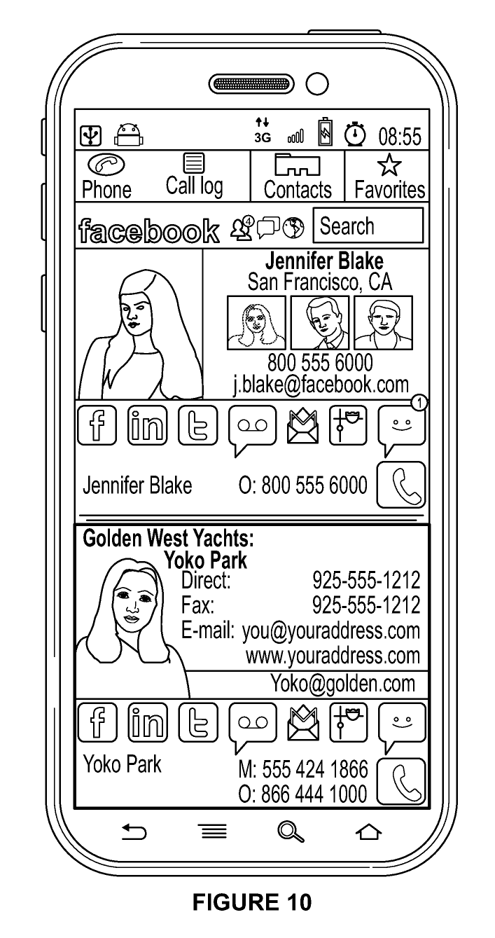

FIG. 10 shows a dynamic multi-portal contacts screen. Dynamic multi-portal contacts let you see who is calling while providing and saving valuable contact information, such as caller's profiles, email addresses, phone numbers and other relevant contact data with one touch on one screen without importing photos or typing. The system dynamically updates all contacts recent and archived with rich relevant data such as social network profiles, past and recent text messages, voicemails, emails and more.

The system can dynamically import relevant information and realtime data, such as social network profiles, tweets, text messages, emails and the like; days after recent and missed calls have been received.

The system makes communicating quick and easy from any mobile device. Simply touch the email address, text message icon, etc. on the digital business card and you are ready to begin. Current and archived emails, text messages, voicemails, etc are dynamically updated anytime they are touched.

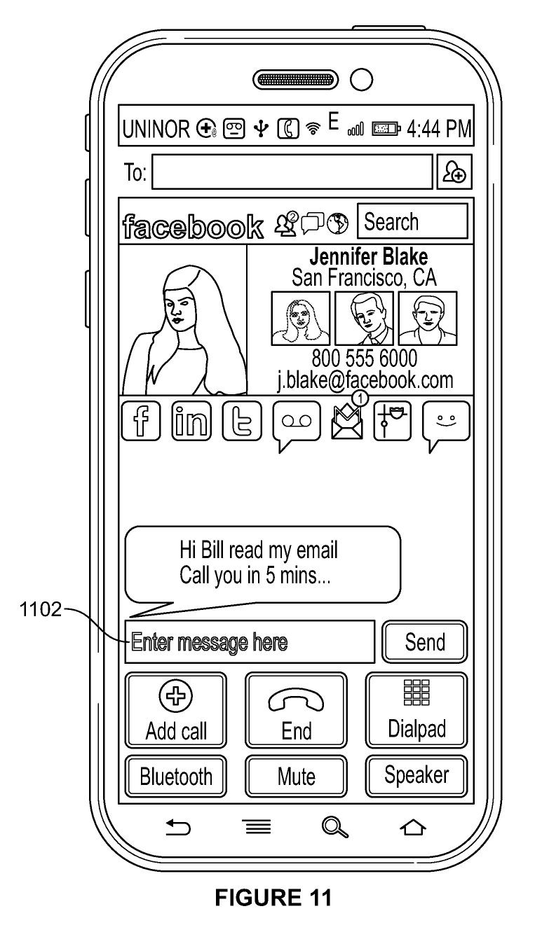

FIG. 11 shows dynamic multi-portal text message screen. The dynamic multi-portal text message system lets you see who is texting you, along with their current profiles, tweets and more anytime after the text message has been received. The system dynamically updates all data icons on digital business cards when touched, including all recent and archived text messages, voicemails, emails and the like. Data icons deliver rich and relevant information with just on touch on the screen.

The system imports current social network profiles, tweets, text messages, emails, pictures, videos, relevant information, and realtime data and more, days after recent and missed calls have been all received all from the same screen.

The system enables callers to send and receive text messages during calls without leaving the call screen. Simply touch the SMS bar during and after the call and you are ready to send and receive messages, video, pictures, and the like, without leaving the call screen. This system removes the 144 character restriction and makes for a richer and robust text messaging experience.

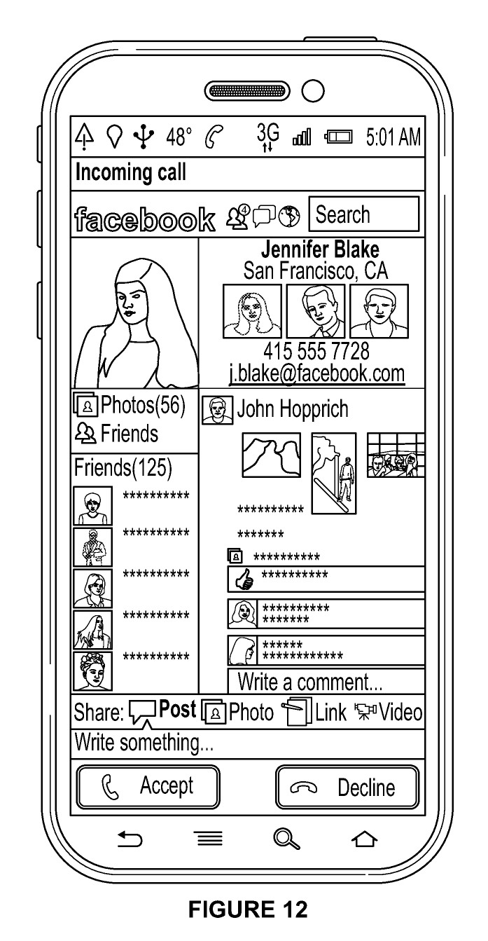

FIG. 12 shows the real time access of a person's social network during a call.

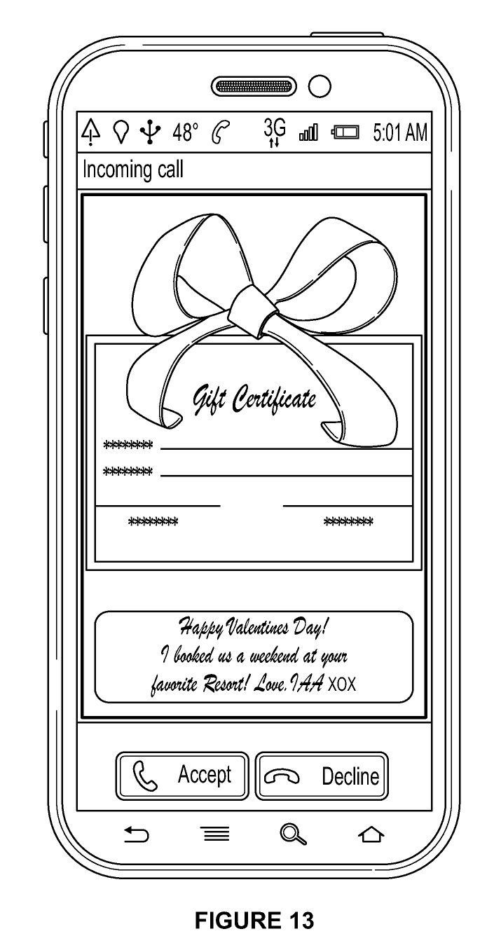

FIG. 13 shows the dynamic gift delivery during a call. A gift certificate can be sent to the recipient during the call. The recipient can then use the gift certificate to purchase items.

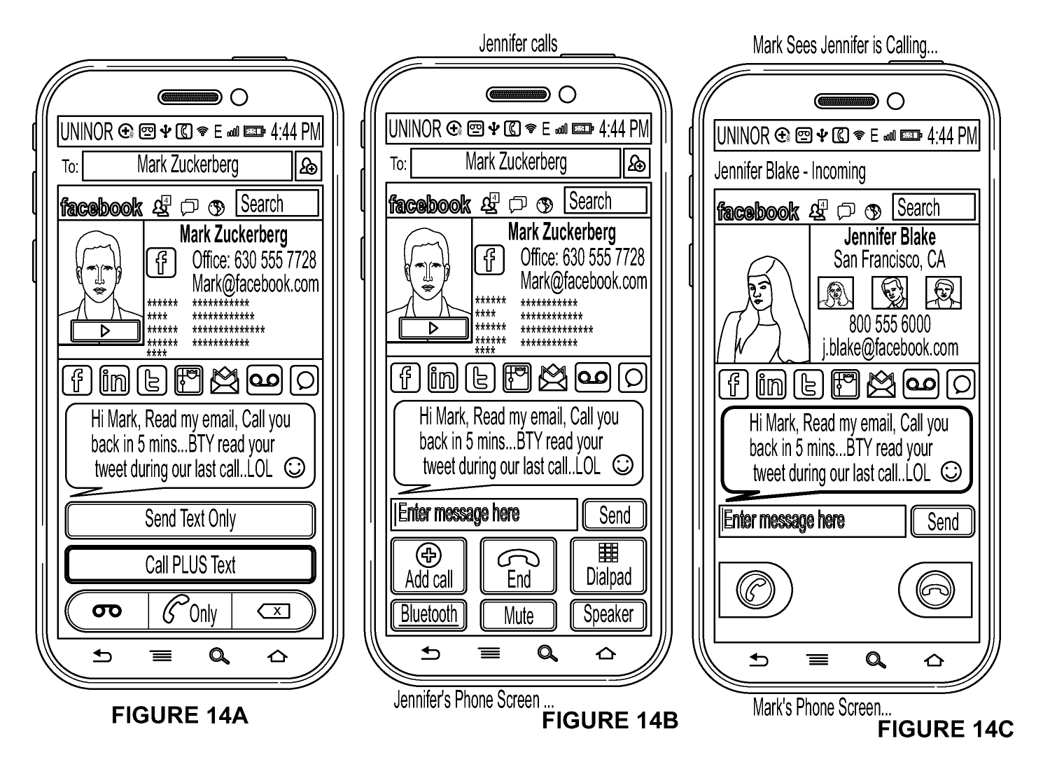

FIG. 14A-C shows one screen instant calling and text messaging without leaving the call screen.

Another embodiment of the present invention is a phone that includes an emergency reserve of power that is available to make an emergency call. The emergency call can be a 911 call or its equivalent. The phone can use the emergency reserve of power to receive another emergency call. The phone can allow for call interruption for emergency calls.

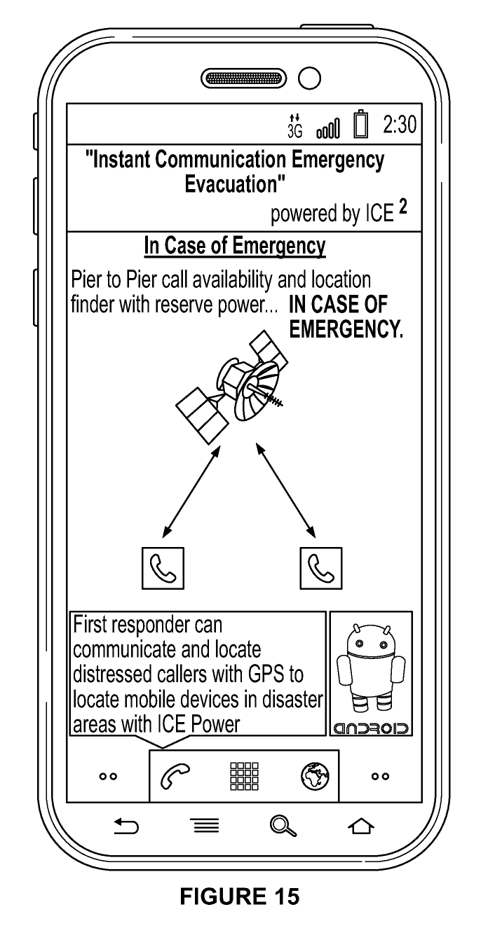

FIG. 15 shows a screen for emergency features of a phone of one embodiment. A mobile safety feature can include reserved battery power that can only be used to receive and call 911. First responders can auto-turn on speaker phone and GPS on mobile devices in order to locate individuals that are in distress. The Mobile “SOS” systems can also auto-initiate calls to all known numbers resident to the disaster area, as well as phone numbers who have used cell towers in the disaster area prior to event.

The Mobile “SOS” enabled devices can also have emergency call interruption. Mobile SOS enabled devices provide selected individuals with an emergency interruption access via a password that allows callers to interrupt a call that is a Mobile enabled device. Callers with enabled devices can interrupt calls during emergencies by replacing ringtones with live voice, replacing ringtones with emergency message. The system enabled devices can interrupt and join live calls as third parties by auto triggering “call waiting” and automatically placing third party on “mute” for private communication between calling party and intended party.

In case of emergency, Mobile reserve power built into every handset is a powerful protection tool and product differentiator in the market place.

Embodiments of the present invention include a phone that automatically produces a display upon receiving or sending a call to another party that allows a simple messaging service (SMS) message to be sent to the another party to the call. As shown in FIG. 11, when a phone call is received or sent in an outgoing call or incoming call, field 1102 allow for a SMS message to be sent to the recipient during the call.

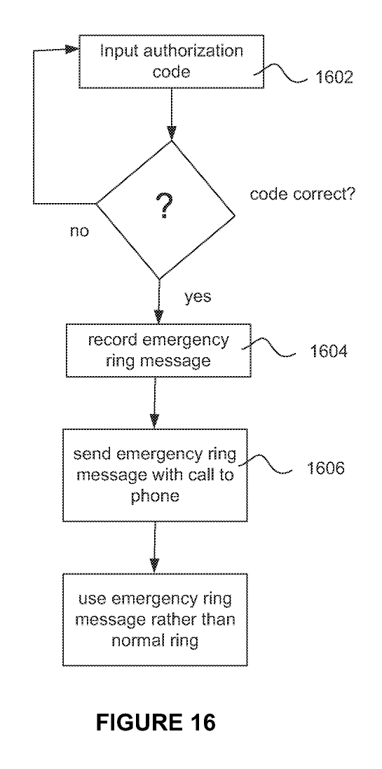

FIG. 16 shows a system that replaces a phone's ring with an emergency message created by the caller to the phone. The phone can allow the replacement of the normal ring when authorized using a pass code.

A pass code can be input by caller in step 1602. If the pass code is correctly input in step 1604, the emergency ring message can be recorded by the caller. In step 1606, this emergency ring message is sent to the recipient's phone. In step 1608, the recorded emergency ring message is used at the recipient's phone, rather that the normal ring. This feature allows for the call recipient's to send messages while talking on the phone. This functionality may be especially useful for conference calls or the like.

The caller can also use an auto interrupt feature which also may use a pass code.

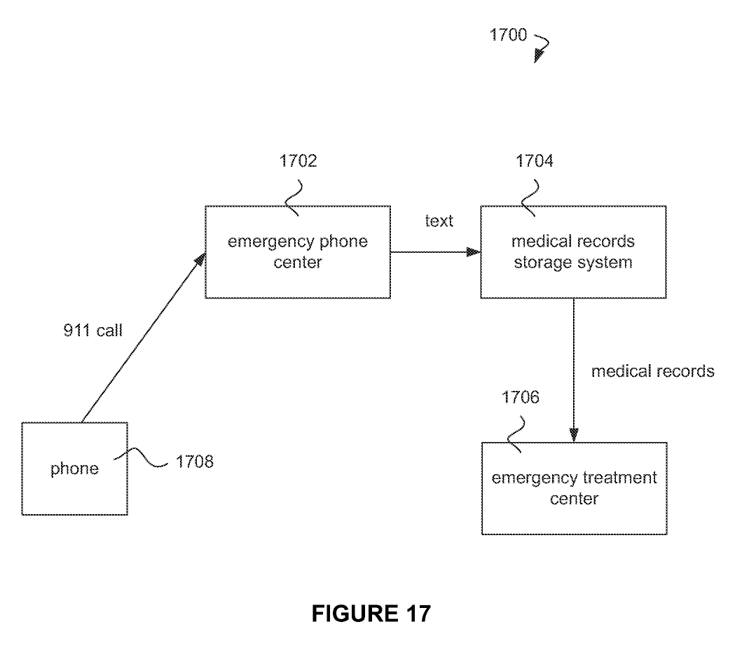

FIG. 17 shows an emergency system 1700 that allows an emergency phone center 1707 to automatically send a signal to a medical records storage system 1704 to release the medical records to an emergency treatment center 1706.

A phone 1708 is used to call the emergency phone center 1702, such as a 911 call center. The phone 1708 can be set up to authorize the transfer of medical records. Alternatively, the emergency phone center 1702 can check an authorization database (not shown).

The emergency phone center 1702 can send a message (such as a text message) to the medical records storage system 1704. The text message can include a code identifying the emergency location. The location of the medical record storage system can be provided by the phone 1708 or obtained from a database. The medical records storage system can be associated with a doctor's office for example.

The medical records can then be automatically sent to an emergency treatment center 1706 for use with respect to the patient. The emergency treatment center 1706 can be the location that treatment is to be given to the user, such as the destination hospital that an injured user is to be sent.

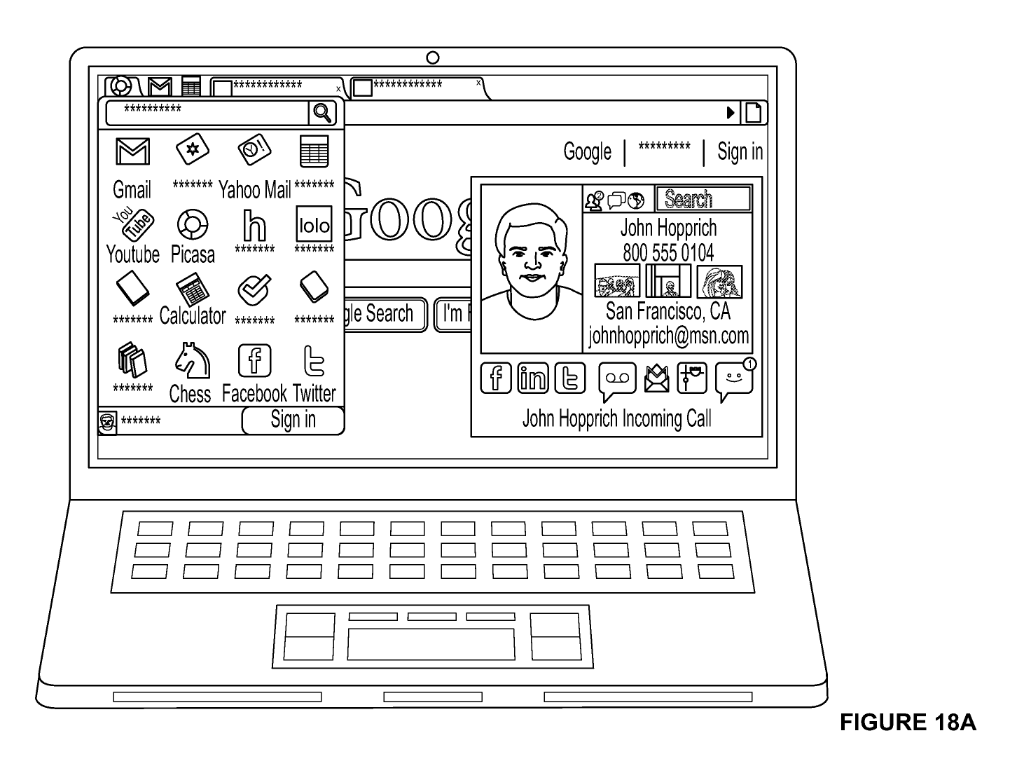

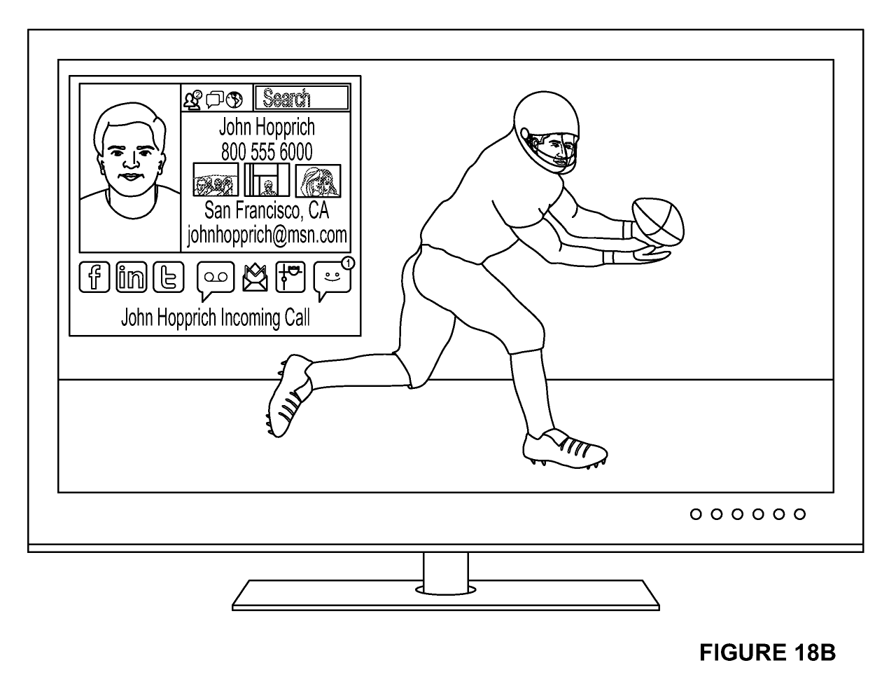

One embodiment is a system that upon an incoming call to a user puts a graphical display includes a photo of a caller onto a display other than the user's phone. FIG. 18A shows such a display on a computer. FIG. 18B shows such a display put onto a television set.

In one embodiment, the television or computer can be registered so that they are associated with a mobile phone. When a call for that mobile phone is received, the display information for the caller is sent to the registered televisions and/or computers. The recipient is thus made aware of the mobile phone call.

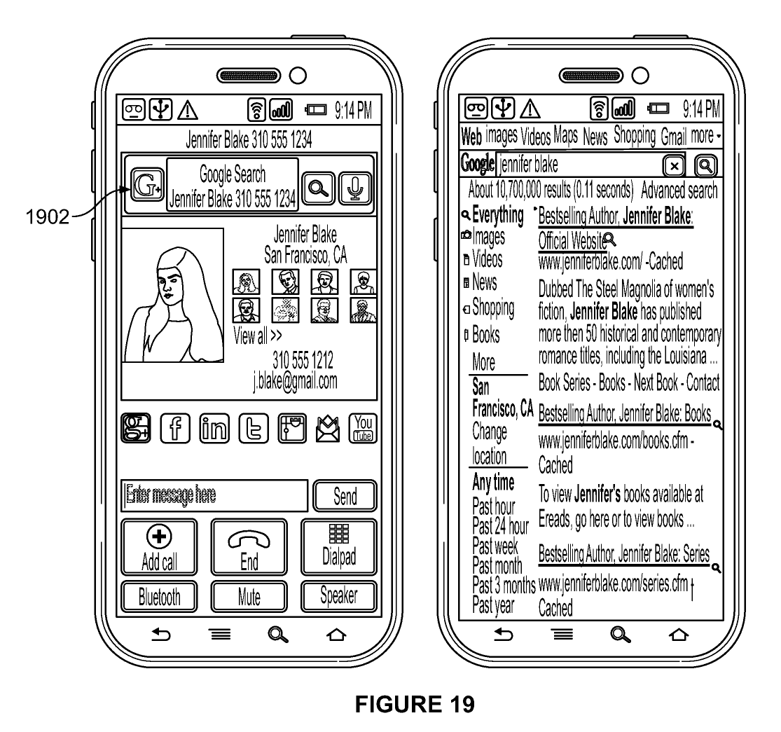

FIG. 19 shows a feature in which upon a call a search engine box 1902 of the phone display is automatically populated with information of the caller (such as the caller's name). This allows a search for the caller to be made at a touch of the button. Thus, the user can easily do an Internet search, such as a Google search of the caller before or during the call. Information to populate the search engine box 1902 can be obtained using the phone number of the incoming call to look up name information either locally or from a central database.

Incoming calls can automatically populate the Google, or other search site, search box 1902 for searches of unknown and known callers. The receiving party can also initiate Google, or other search site, searches during calls using text, voice or scroll down based on previous searches. Google, or other search site, searches during calls can be used for making restaurant reservations, finding movies times, etc. during the same call without leaving the call or call screen.

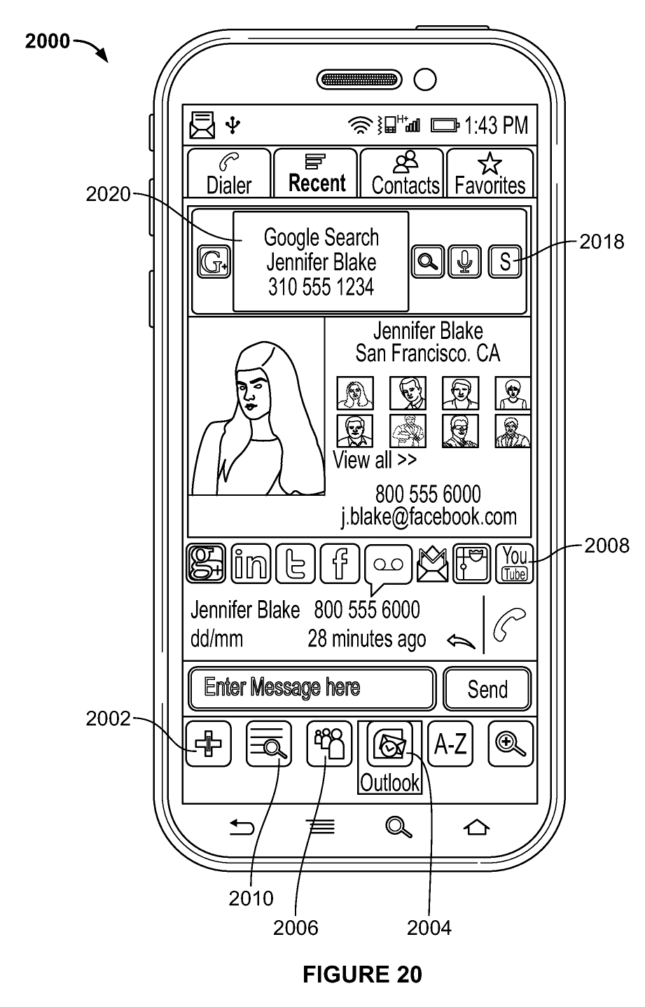

FIG. 20 shows exemplary buttons of one embodiment of the present invention.

A Digital Persona Presentation allows you the option of sharing your social circle with your callers. One click and your caller can see your friends and write comments to them. The foregoing description of preferred embodiments of the present invention has been provided for the purposes of illustration and description

Emergency Contacts button 2002 can be used to provide First Responders with Immediate access to your Physician, Critical Medical Information, Medical records and the like. Emergency Contacts can also be located here for quick and accurate notification of loved ones.

A email button 2004 can be used to auto-sync with Outlook or another email system.

A social network contacts button 2006 can provide for searches by Social Network groups. One click and all of the contacts associated with a particular social network come to the top in alphabetical order.

A video site button 2008 can be used to provide a tagging mechanism for both videos they've produced or Liked. The tagging can allow a user to add their E-mail address and/or phones in order to make locating a specific video easy and accurate. In addition, producers of videos can now receive real time feedback and comments from their viewing audience. More importantly, you can now send and share your personal videos or your favorite videos to anyone you call anywhere in the world.

A contacts button 2010 provides for searches by family members, business contacts, interest groups, phone numbers e.g. area code, etc.

Phone 2000 allows for a visual presentation during a phone call. The phone includes a share button 2018 that, when pressed, causes the visual presentation to be shared with the other party to the phone call.

The visual presentation can be of a webpage, a map or any other visual presentation.

For example, the user can do a web search from the search bar 2020 and then share the search or other webpage, with the other caller by pressing the share button 2018. This can cause the URL to be sent to the other phone for display or alternatively an image can be sent to the other phone.

Looking again at FIG. 9, a phone 900 with a recent call list 902 includes data obtained from a network for a caller's telephone number. The data includes a name 904 and a picture 906. The recent call list 902 highlighting those callers in the recent call list who are not in a contact list.

The highlighting can be a colored border 908. The recent calls list 902 can allow a user to select a highlighted recent call 908 and add its data to the contact list.

For example, clicking or touching on a highlighted recent call can bring up a box that asks whether to add the highlighted recent call to the contacts list. Alternatively, a button can be displayed for the highlighted recent call to allow it to be added to the contacts list.

It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A phone that allows a user to input profile data that is provided to another phone upon the phone calling or receiving a call from the another phone, the profile data not needing to be stored at the another phone, the profile data including an image that is displayed at the another phone upon an incoming or outgoing call.

2. The phone of claim 1, wherein the profile data is stored at a server.

3. The phone of claim 1, wherein the display at the another phone includes data from a social network site.

4. The phone of claim 1, wherein the display at the another phone includes email access to the latest emails from the user.

5. The phone of claim 3, wherein the display includes a message preview of one of the latest emails form the user.

6. The phone of claim 1, wherein the display includes a latest text message from the user.

7. The phone of claim 1, wherein the display is selectable by the user to be different for incoming and outgoing calls.

8. The phone of claim 1, wherein map data for the user is provided to the another phone.

9. The phone of claim 1, wherein the data and image is selectable by the user.

10. A server to provide image and other data to a phone upon incoming and outgoing calls from a second phone, the server providing the image for a user who has set up a profile, the image being provided to the phone from the server without the image needing to be stored at the phone, an image being displayed at the phone upon an incoming or outgoing call.

11. The server of claim 10, wherein the display at the phone includes data from a social network site.

12. The server of claim 10, wherein the display at the phone includes email access to the latest emails from the user.

13. The server of claim 12, wherein the display includes a message preview of one of the latest emails form the user.

14. The server of claim 10, wherein the display includes a latest text message.

15. The server of claim 10, wherein the display is selectable by the user to be different for incoming and outgoing calls.

16. The server of claim 10, wherein map data for the user is provided to the phone.

17. The server of claim 10, wherein the provided data and image is selectable by the user.

18. A phone that provides a display upon an incoming or outgoing call, the display including links to relevant email, SMS messages and social network information for the other party to the call.

19. The phone of claim 18, wherein contents of the display is selectable by the other party to the call.

20. The phone of claim 18, wherein separate displays are provided for incoming and outgoing calls.

21. A phone that includes an emergency reserve of power that is available to make an emergency call.

22. The phone of claim 21, wherein the emergency call is a 911 call or its equivalent.

23. The phone of claim 21, wherein the phone uses the emergency reserve of power to receive another emergency call.

24. The phone of claim 21, wherein the phone allows for call interruption for emergency calls.

25. A phone that automatically produces a display upon receiving or sending a call to another party that allows a simple messaging service (SMS) message to be sent to the another party to the call.

26. The phone of claim 25 wherein the call is an outgoing call.

27. The phone of claim 25 wherein the call is an incoming call.

28. A system that replaces a phone's ring with an emergency message created by the caller to the phone.

29. The system of claim 28, further comprising an auto interrupt feature.

30. The system of claim 29, wherein the phone allows the auto interrupt using a pass code.

31. The system of claim 28, wherein the phone allows the replacement of the ring using a pass code.

32. An emergency system that allows an emergency phone center to automatically send a signal to a medical records storage system to release the medical records to an emergency treatment center.

33. The system of claim 32, wherein the medical records are released to the emergency treatment center as a result of a text message from the emergency phone center.

34. The system of claim 33, wherein the text message includes a code identifying the emergency location.

35. The system of claim 32, wherein the emergency phone center is a 911 call center.

36. The system of claim 32, wherein the phone calling the emergency phone center automatically authorizes the release of the medical records.

37. A system that upon an incoming call to a user puts a graphical display includes a photo of a caller onto a display other than the user's phone.

38. The system of claim 37, wherein the display is on a computer.

39. The system of claim 37, wherein the display is put onto a television set.

40. A phone that upon receiving a call from a user automatically populates a search engine box with the caller's name, so as to allow a search engine search for the caller during a call.

41. The phone of claim 40 that automatically looks up the caller's name using a phone number of the caller.

42. A phone that allows for a visual presentation during a phone call, the phone providing a button that, when pressed, causes the visual presentation to be shared with another party to the phone call.

43. The phone of claim 42, wherein the visual presentation is of a webpage.

44. The phone of claim 42, wherein the visual presentation is of a map.

45. A phone where a recent call list includes data obtained from a network for a caller telephone number, the data including a name and a picture, the recent call list highlighting those callers in the recent call list who are not in a contact list.

46. The phone of claim 45, wherein the highlighting is a colored border.

47. The phone of claim 45, wherein the recent calls list allows a user to select a highlighted recent call and add its data to the contact list.
